(19) United States
(12) Patent Application Publication
(10) Pub. No.: US 2008/0263162 A1
(43) Pub. Date: Oct. 23, 2008

(54) Modeling User-Initiated Requests and Status Updates Within an Email Message

(75) Inventors: Jeffrey Staiman, Bellevue, WA (US); Zoltan Pekic, Seattle, WA (US); William Qian, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/941,004

(22) Filed: Nov. 15, 2007

Related U.S. Application Data
(60) Provisional application No. 60/913,213, filed on Apr. 20, 2007.

(51) Int. Cl. G06F 15/16

(52) U.S. Cl. 709/206

(57) ABSTRACT

The embodiments described herein generally relate to systems and methods for modeling a user-initiated request to a business process application as an email form. It is often necessary for individuals to communicate, or exchange information, with a business application. Inefficiencies and delays arise where individuals are required to work within the context of the business application to accomplish desired actions or to determine the status of a requested action. By allowing a user to request an action from a business application using an email form, such inefficiencies and delays are minimized, if not eliminated altogether. A user may therefore initiate a request to a business application by working within the familiar and readily-available UI of the user's general-purpose email client and may receive status updates regarding such a request with the same UI of the original request.

### RELATED APPLICATION

This application claims priority to U.S. Provisional Application Ser. No. 60/913,213, filed on Apr. 20, 2007, and entitled, “Modeling User-Initiated Requests And Status Updates Within An Email Message,” which is hereby incorporated in its entirety for all that it teaches.

### BACKGROUND

The use of electronic mail, or email, has become an integral, if not necessary, part of nearly every individual's life. Indeed, especially in the business context, individuals use email at least several times a day. In addition to using email as a part of their business activities, individuals also often need to interact with a computer system or business process application to accomplish a certain task or make necessary requests. For example, a business process application may be set up to complete a certain business practice, such as enrolling individuals for health benefits, updating human resource information, adding users to, or removing members from, an email distribution list, etc. A user may desire to join or leave a group or change one's address or telephone information. Further, a user may wish to determine the status of his/her request, such as finding out whether the request was approved or rejected. To take such actions, individuals have been required to work within the business process application in and of itself to interact with the application for purposes of accomplishing the desired, or required, tasks or status checks.

Requiring the user to access the business process application to complete a certain task often leads to a host of problems and inefficiencies. For example, where users are required to work within the business application context, they are required to be connected to the application and then, once connected, to navigate through the application's user interface (“UI”) to formulate the request. Where an individual desires to perform a follow-up regarding the status of the request, the user may be required to repeatedly navigate to the business application, requiring the user to either switch the context within which he/she is working or fail to obtain such information altogether where the user is unable to connect to the application. Thus, requiring the user to access the business process application to complete the desired action may cause delays, confusion, and errors where, for example: (1) at the time of desiring to make a request to the business application, the individual is working from a site with limited or no connectivity, or access, to the corporate business network and resulting business application, in which a mobile user, for example, may have greater connectivity to his/her email server than to corporate business applications; (2) the individual postpones switching contexts from the email or message interface to the business process application, i.e., navigating to a given website to complete the desired action; (3) the user does not know which business process application to contact to formulate the desired request or perform a status check; and (4) the individual is unable to accomplish the desired task in a timely manner as a result of unfamiliarity with the business process application user interface and functionality from which the appropriate task is requested. Further, delays and inefficiencies in checking on the status of a request are also present where the user is required to navigate to the business application, if such location is even known to the user, to check on the status of a particular request.

Requiring a user to navigate away from the email interface to access a business application not only consumes time but also requires the user to give up functionality inherent to email and not provided by most business applications. Such functionality consists of, by way of example only, the ability of an email user to save a partially-completed message and finish such message at a later time or the ability to “carbon copy” other users when sending the message. Such functionality is typically not available in most business application contexts.

Although specific problems have been addressed in this Background, this disclosure is not intended in any way to be limited to solving those specific problems.

### SUMMARY

Embodiments of the present invention generally relate to enabling a user to initiate a request to a business process application from within the context of the user's email client and to thus model the user's request to the business process application as an email form. More specifically, a method is provided for initiating a request to a business process application by a user as an email form. Further embodiments of the present invention relate to providing status updates regarding the processing of a request through utilization of the email client UI of the original request.

In accordance with embodiments of the present invention, a method is provided for allowing a user to select the action of making a certain request, e.g., a request to join a certain group, from within the UI of a general-purpose email client in which the user is working. An interactive UI window, or form, appears which represents the mail message and whose body contains fields that the user can complete, or fill-in, to indicate the specifics of the request he/she wants to make, e.g., to join a specific group. The form which appears to the user is a UI representation of the mail message data that guides the user as to what information he/she needs to provide, or, in other words, guides the user to enter the information needed to process the request. Thus, the user does not simply send a text request. Rather, the user completes both required, and optional, information in the form provided to the user upon the user's indication to make a request. After completing the form for the requested action, the user selects the necessary control, button or other indicator to send the request. The message is then sent to the email server that manages the user's email box. The receiving email server then sends the message to the email server that manages the mailbox that is monitored by the relevant business application. In addition to human-readable text that summarizes the request, the message that is sent contains data in a specific format, or data structure, embodying the request. The data structure is received by the business process application which decodes the message, extracts the data, and performs the requested action. Without such data structure, the business process application could not understand the request by the user.

Further embodiments relate to the provision of updates regarding the status of a requested action and of the resulting business process application from within the UI of the original email message. In an embodiment, after sending a request, a user may open the request from the user's “Sent Items” folder in the user's email client to see the status of that request in the UI of the originally sent email message. In such embodiments, the email client has information to be able to update the original email item to reflect the status of the request. In another embodiment, a human-readable status update message is sent to the user from the business application. The update message is correlated to the previous request and the original request is then updated so that it reflects the new information contained in the status update, e.g., “Request was approved,” “Request was rejected,” “Request is pending approval,” etc. The business application or the user may initiate the sending of such a status update in accordance with embodiments of the invention. Where a status update is sent, the UI of that status update can be modified, or refreshed, to reflect the most recent knowledge of the process. The status updates can thus be sent via email and/or may be in the UI of the original request in accordance with embodiments of the present invention.

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope. The foregoing general description and the following Detailed Description should not be considered to be restrictive. Features or variations may be provided in addition to those set forth herein. For example, embodiments may be directed to various feature combinations and sub-combinations described in the Detailed Description.

### BRIEF DESCRIPTION OF THE DRAWINGS

The accompanying drawings, which are incorporated in and constitute a part of this disclosure, illustrate various embodiments of the present invention. In the drawings:

FIG. 1 illustrates a networked operating environment where aspects of embodiments of modeling a request initiated by a user to a business application as an email form may be practiced in accordance with an embodiment of the present invention. In addition, the sending of a status update to a user using the UI of the original email request may also be practiced in the environment of FIG. 1 in accordance with another embodiment of the present invention.

FIG. 2A is a flow diagram illustrating the operational characteristics of a method for sending a user request to a business application, through the use of an email form and a general-purpose email client, in accordance with an embodiment of the present invention.

FIG. 2B is a flow schematic depicting in high-level form the request by a user to an application as an email form and the correlating sending of a status update as an email form to the user from the business process application, in accordance with an embodiment of the present invention.

FIG. 3 is a detailed flow schematic depicting the operational characteristics of a method for modeling FIG. 2A's user's request to a business process application as an email form.

FIG. 4 is an exemplary screen shot of a user interface in a general email client providing functionality for a user to request to add members to a group in accordance with an exemplary embodiment of the present invention.

FIG. 5 is a flow diagram depicting the operational characteristics of a process for a business process application to respond to the exemplary request from a user to join a group shown in FIG. 4 in accordance with an embodiment of the present invention.

FIG. 6A is a flow diagram illustrating the operational characteristics of a detailed process of a business process application receiving a message from a user requesting an action in accordance with an embodiment of the present invention.

FIG. 6B is a flow diagram illustrating the operational characteristics of a process for sending a status update to a user from a business application responding to a user-initiated request.

FIG. 7 is a block diagram of a system including a computing device for use in the networked operating environment of FIG. 1 in accordance with an embodiment of the present invention.

### DETAILED DESCRIPTION

The following Detailed Description refers to the accompanying drawings. Wherever possible, like structures and elements shown throughout are indicated with like reference numerals. Dashed lines may be used to show optional components or operations.

According to embodiments of the present invention, a method and system for enabling a user of an email client to initiate a request of an action by a business process application from within the familiarity and convenience of the UI of the user's email client is disclosed. A method and system is also disclosed for allowing the user to check on the status of a request to a business process application from within the familiar UI of the user's email client. Individuals often require action from a business process application. There are numerous types of actions which may be requested. For example, a user may request to change human resources information, to join a distribution list, to remove one's membership in a group, etc.

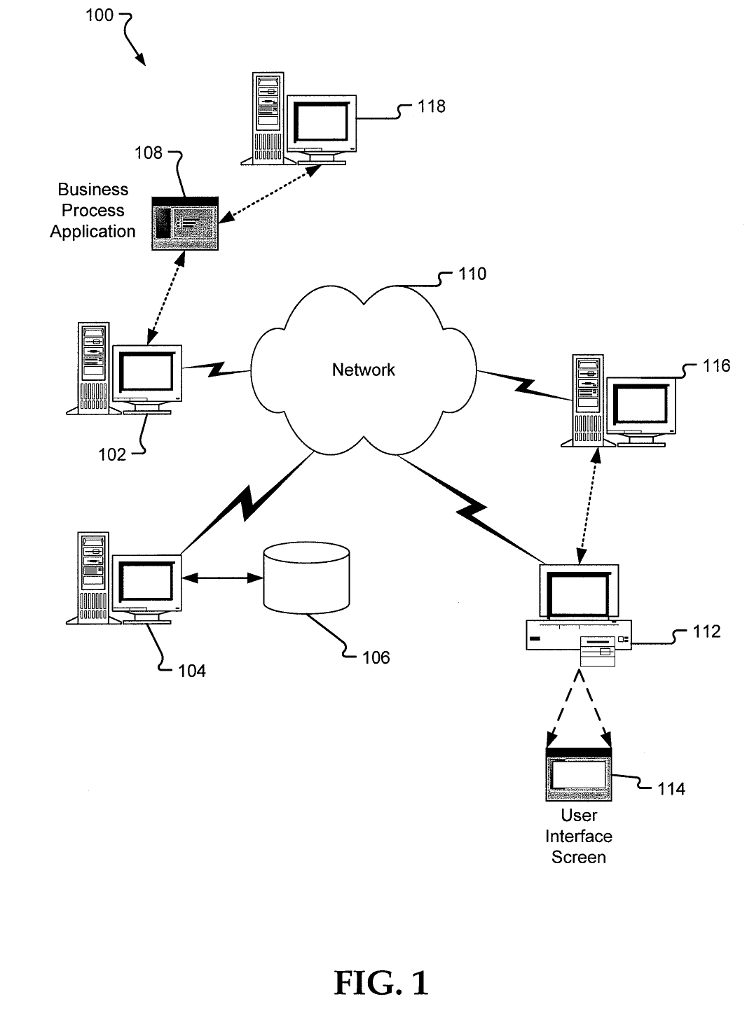

A network environment 100 for modeling a request initiated by a user to a business process application as an email form and for providing a status update to a user in the UI of the original email is shown in FIG. 1. In a particular embodiment, the user of computer system 112 formulates a request to the business process application 108 as an email form using the familiar UI of the email client depicted in user interface screen 114 and sends such request to the business process application 108 through the use of the user's email client in accordance with an embodiment of the present invention.

In an embodiment, the sending and receiving process for the request works as follows: the user formulates a request for a particular business process application 108 using client computer 112 and the familiar UI of the email client depicted in user interface screen 114. The email client then sends the formulated request to the email server 116 managing the user's email mailbox. Using the network 110 for transmitting the requests and status updates, the email server 116 then sends the message to the email server 118 managing the mailbox monitored by the business application 108. In an embodiment, the network 110 may include multiple companies, e.g., the user using client computer 112 for sending a request may be at a different company, such as a partner company, than the business application 108. Examples of business process application 108 include, although are not limited to, applications used by companies to manage email distribution lists, accounting data, human resources information, expense reporting, etc. As shown in the embodiment depicted in FIG. 1, business process application 108 executes on server 102, and its mailbox is managed by email server 118. Data for the business process application 108 is stored in the database management system 106 and is run by server 104. In other embodiments (not shown), a single server 102 may run both the business process application 108 and the database management system 106. In other embodiments, server 102 may also manage the business process application 108's mailbox. Email servers 116 and 118 may also be replaced by a single server managing and monitoring both the user's and the business application's mailboxes. In other embodiments, servers in addition to email servers 116 and 118, e.g., a server farm, may be used for managing the mailboxes of the business application and of the user.

In embodiments, business process application 108 executing on the server 102 has most, or all (according to some embodiments), of the business logic. Determinations of the necessary tasks for execution, for example, are based on the logic/business rules stored on the server. Two components (not shown) related to the email requests of the present invention may exist on server 102, namely, a mail listener, or monitor, and a mail sender.

Networked system 100 is merely an exemplary embodiment. Other computing devices may also participate in the networked system 100. For example, the computer network 110 may include a secure network such as an enterprise network, or an unsecure network such as a wireless open network. The computer network 110 may include wired media such as a wired network or direct-wired connection, and wireless media such as acoustic, RF, infrared and other wireless media. Further, the exemplary environment of networked system 100 may be considered in terms of the specific components mentioned, e.g., server, processor, storage system, etc., or, alternatively, may be considered in terms of the analogous modules corresponding to such units, e.g., executing or processing module, recording or storing module, display module, etc.

In an embodiment, on the computer system 112, there exists a general-purpose email client application, e.g., Microsoft Office Outlook 2007®, and, according to some embodiments of the present invention, an email client add-in, e.g., Outlook add-in. “Outlook” is offered for example purposes only and is in no way intended to limit the scope of this invention. General-purpose email clients include, but are not limited to, email clients executing in a dedicated program on a local computer, i.e., a “rich client,” or email clients whose functionality is realized by code executing on a server. Where the functionality is realized by code executing on a server, the functionality on the email client is limited primarily to rendering the user interface, i.e., a “web client” or “thin client.” Any number of types of general-purpose email clients reasonably known to those of ordinary skill in the art could be used in accordance with embodiments of the present invention.

In accordance with an embodiment of the present invention, the email client add-in, if one is used, provides functionality beyond that provided in the email client application. The add-in integrates with the email client using publicly disclosed APIs and provides the UI that allows the user to enter his/her request and send that request to the server-based business application from the email client. In embodiments, the add-in modifies the email client to provide appropriate UI controls to the user depending on the request desired by the user.

In an embodiment, the email client and/or email client add-in existing on computer system 112 maintains a list of business process application addresses and thus knows where to send a given request based on the type of request made, e.g., a request to join the Sporting Goods group; a request to change Human Resources information, etc. In other words, the email client or email client add-in knows the email address of the destination business application. In an embodiment, the UI to send the mail, and the functionality for sending the mail, are primarily the responsibility of the email client. In another embodiment, the email client add-in is integrated with the email client to provide such functionality. In sending the message request from the user, an embodiment uses a protocol for various elements of the system to negotiate the email address to which to send a specific request. In further embodiments, the user may be required to know, and enter, the email address of the business application that will process the request, i.e., the destination business application. The user may find such addresses in the user's email address book, in which the addresses may be listed in a standard, recognizable form in accordance with embodiments of the present invention. In another embodiment, all user requests are sent to one email address. Specific Inbox rules or policies at the receiving mailbox automate the delivery of the requests to the correct address for the particular request in accordance with an embodiment of the present invention. In another embodiment, a service is used to determine the correct address correlating to a particular request, in which a protocol may be used for enabling communications between the email client or add-in and such service.

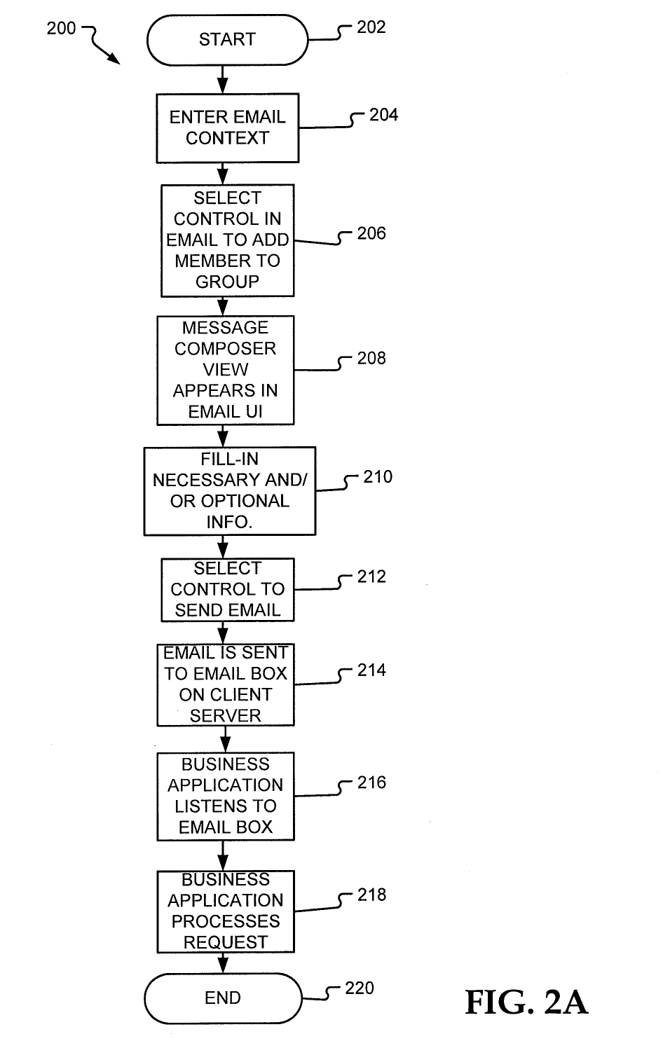

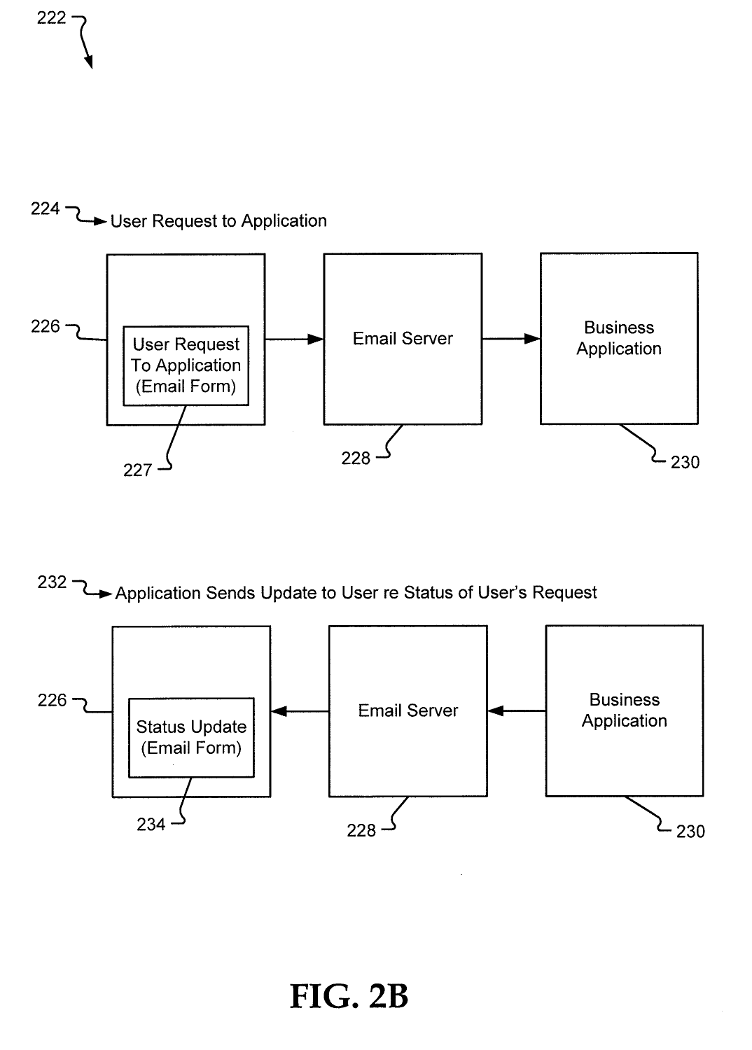

Turning to FIG. 2A, process 200 illustrates the steps for allowing a user to initiate a request to a business process application as an email form and, thus, from within the email UI of the user's email client through the use of the computing device 112 of FIG. 1 in accordance with an embodiment of the present invention. More particularly, process 200 relates to the exemplary method of initiating a request to add a member to a particular group. In other embodiments, numerous types of requests reasonably known to those of ordinary skill in the art could be used.

Process 200 begins with start operation 202 in which the user opens his/her email client, such as, Microsoft Office Outlook 2007®. Next, in enter email request context operation 204, the user, in an embodiment, selects a control, icon, or other indicator from the Inbox view to make a request, e.g., select “Forms” or “Groups,” etc. In an aspect of an embodiment, the user may select to join a group by simply clicking on the “Groups” control, icon or button, or other similar control, icon, button, or UI, in the user's Inbox view. In such an embodiment, the user may select to “Join Group,” “Leave Group,” “Add Members to Group” operation 206, “Remove Members from Group,” etc. In another embodiment, the user can select a control, button, icon, or other indicator to select “Forms . . . ” in general and then receive either a pop-up dialog box of available forms for making requests or a scroll-down menu of available forms, e.g., vacation-time leave form, change of address form, etc. In yet another embodiment, the user can select to create a “New” email message and a message composer view, for example, opens. From within this email message, the user selects a control indicating to add a member to a group in select add member operation 206, in accordance with an embodiment of the present invention. A person of ordinary skill in the art would understand that there could be any number of ways, without departing from the spirit and scope of the present invention, to show a user a choice of forms or to allow the user to obtain the message composer view for a request useful to a particular context. For example, in accordance with embodiments of the present invention, requests could be relevant and accessible via a calendar view, e.g., a request for vacation time for a future date marked as “Out-of-Office;” a contact view, e.g., a request to add a personal contact to the corporate database; and/or a tasks view, e.g., a request to delegate a task that is shown in the email client and tracked in another application, etc. In embodiments, UI controls would be associated with any of these contexts. While the above-described embodiments have related to forms invoked by the UI of the email client, the email client or email add-in can fetch the needed form from the business process application in accordance with another embodiment of the present invention.

Upon indicating the user's request to add a member to a group, a form 208 appears for the user to complete with fill-in information operation 210. In accordance with embodiments of the present invention, the form 208 is the UI representation of mail message data that helps the user complete the form, such as, by way of example only, checkboxes, auto-fills, data validation, etc. In embodiments, options for the user for adding a member to a group are shown, such as a list of names of potential members, a list of possible groups, etc. Where a list(s) is displayed, this list(s) may include entries derived from a variety of sources, as appropriate for a particular context. For example, a list(s) may be displayed showing: (1) the user(s) or group(s) on the email that the user was reading at the time of making the request; (2) the groups that the user is already a member of, etc. In an embodiment, such lists may be automatically displayed to the user, in which the user may mark a given checkbox to select a member for adding and select another checkbox to indicate the group to which the user wants the member assigned. In another embodiment, the user may click separately on the controls, icons or buttons of “Members . . . ” and “Groups . . . ” to open dialog boxes displaying such lists as overlays to the message view screen. Any number of required and optional fields in form 208 reasonably known to those of ordinary skill in the art could be used.

An example of an optional field is a business justification for the request, in which the user may enter text in the text entry field of the message as a part of fill-in operation 210. Information typed in the business justification field cannot be understood by the business application or email client. Rather, such information may only be read and understood by a human receiving the request. The email client and business application may only understand data in a specific format, in which such data is hidden from view of the user in accordance with an embodiment of the present invention but is carried with the message as the necessary data structure for enabling the request by the user. In such an embodiment, the data structure does not have a human-readable UI. The business process application thus works based on the data structure which is not easily visible, and may even be invisible altogether in some embodiments, to the end user. In such an embodiment, the email item in and of itself, e.g., located in “Sent Items,” also has human-readable text that reflects most or all of the data elements in the data structure. This human-readable text enables the user to see what the email item was later on. In other embodiments, the data structure is itself visible to the user. In further embodiments of the present invention, such data structure may be encoded using encryption methods or rights management technology, among other possible methods or technologies reasonably known to those of ordinary skill in the art, to preserve the confidentiality, if necessary, of any requests which may be intercepted after transmittal by the email user or before receipt of a status update by that user. In another embodiment, the request may be processed by the business application based on the raw text in the email message request and takes action to put the information into the right structure. By putting the data of the request into a certain structure, the application can easily parse, validate and use the information to process it.

Upon completing form 208 in fill-in operation 210, the user next selects to send the request to the business application in send operation 212, in which the user clicks on the “Send” control or “Send” icon, or any other type of indicator, in accordance with embodiments of the present invention, to send the email request.

Upon sending the email message, this message is transmitted to the email box on the email server in which the user is working, such as server 116 in FIG. 1, in send operation 214. The request sent will appear in the “Sent Items” box of the user's mailbox, and, in another aspect of an embodiment, the request will also appear in the preview pane of the user's mailbox as a summary of the request made. For example, the message may show: “Request to add members to groups,” who it was sent by, the date of the request, who it is sent to, and such information as: “User has requested following group membership change: Add Members: To Groups: ,” and the justification given, if any. A person of ordinary skill in the art would reasonably understand that any type of UI and message format may be used to display the request in the user's “Sent Items” box and associated preview panes and message views.

In accordance with embodiments of the present invention, business process applications regularly, periodically, or upon event triggers, monitor, or listen, to the email server's mailbox to which they are configured to listen. As discussed above, the business application mailbox is managed by an email server 118 which is often, if not always in the case of a large corporate network, a different email server from the one that manages the user's email box, such as server 116 shown in FIG. 1. Thus, in listen operation 216, the business application, through, for example, a mail agent associated with the business application, listens to the email server to which it is configured for such monitoring to see if any new and applicable message requests have appeared. Where a new message is found, the business process application processes the request in process operation 218. Process 200 thereafter terminates at end operation 220.

Turning to FIG. 2B, a high-level flow diagram is depicted showing the operational characteristics of an exemplary method and system 222 for a user to request action from a business application 224. Block 226 represents the email client, which as discussed, may be any type of general-purpose email client in accordance with embodiments of the present invention. Within the email client 226 in operation 224 is the user request to the business application as an email form 227. This user request is sent to the email server 228 monitoring the user's mailbox and from there to the business application 230. For illustrative purposes, only one email server 228 is shown in operation 224 of FIG. 2B. One server may monitor both the email client's and the business application's mailboxes. Or, in another embodiment, two servers, or even a server farm, may be used. As noted above, any number of types of ways of determining where to send the user request may be reasonably understood by those of ordinary skill in the art.

In accordance with further embodiments of the present invention, the functionality and interactions of the email client with the business process application also enable the business application 230 to send a status update regarding the user's request to the user in send status update method 232. In such an embodiment, the business process application 230 composes and sends a status update regarding the request to the email server managing its mailbox. In an embodiment, the correlation of the status update with the user request is accomplished in the email system on the email server of the business application. Such correlation may occur through the use of a process identification (“process ID”). However, such correlation may be accomplished in other ways. In another embodiment, the correlation of the status update with the application request occurs on the email client. After sending the status update to the email server managing the business application's mailbox, the status update is then sent to the email server managing the user's mailbox. As noted, for illustrative purposes, only one email server 228 is shown in operation 232 of FIG. 2B. The correlation of the status update with the applicable request may occur on a single server managing both the business application's and the email client's mailboxes. Alternatively, where more than one server is used, the correlation may occur on any of such servers in accordance with embodiments of the present invention.

Upon receipt of the status update, the email server 228 sends the status update to the email client 226, with the status update 234 shown in the email form and UI of that originally used by the individual in formulating the request from within the context of the user's email client 226 and associated UI. In accordance with an embodiment of the present invention, the status update may contain any type of information, such as, by way of example only, notification that the “Request is in-process,” “Request was approved,” “Request was rejected,” “Request is pending approval,” “Request is suspended or on-hold,” etc. The status update email may thus contain human-readable text that the user is able to read and understand. Whether or not human-readable text is present, the update has machine-readable content to update the UI, in which the machine-readable content may or may not be visible to the user and may or may not be human-readable. The status update may contain any number of notice types and be displayed in a number of ways, as may be reasonably understood by one of ordinary skill in the art.

Operation 232 shows the sending of a status update from the business application 230 to the email client 226. In an embodiment, the status update is sent via email to the email client and to the user's Inbox. In another embodiment, the status update may be displayed to the user when the user re-opens the original request he/she originally sent, in which such request would now be located in the user's “Sent Items.” In such an embodiment, the last-known, or most recent, state of a process would be displayed to the user. The display of a status update, or of multiple status updates, within the original email item thus correlates such status updates regarding a business application with the email request, in which such correlation is able to occur even though the email server has no particular understanding of the business processes relevant to the request. In other embodiments, UI in the email client enables the user to see the status of multiple requests in one user interface.

Further, in accordance with an embodiment of the present invention, the business application determines where to send the status update through identification of the user's email address provided in the original message request. Or, in another embodiment, the message request contains a process ID which can be cross-referenced with other data available to the business application to determine which user(s) need to have updates sent to them. This process ID accompanies the overall data structure sent with the user request. In other embodiments, the email client or email client add-in has knowledge a priori of the address to which the user's request should be sent. In other embodiments, the destination address could be determined through the use of a protocol for various elements of the system to negotiate the email address to send a specific status update.

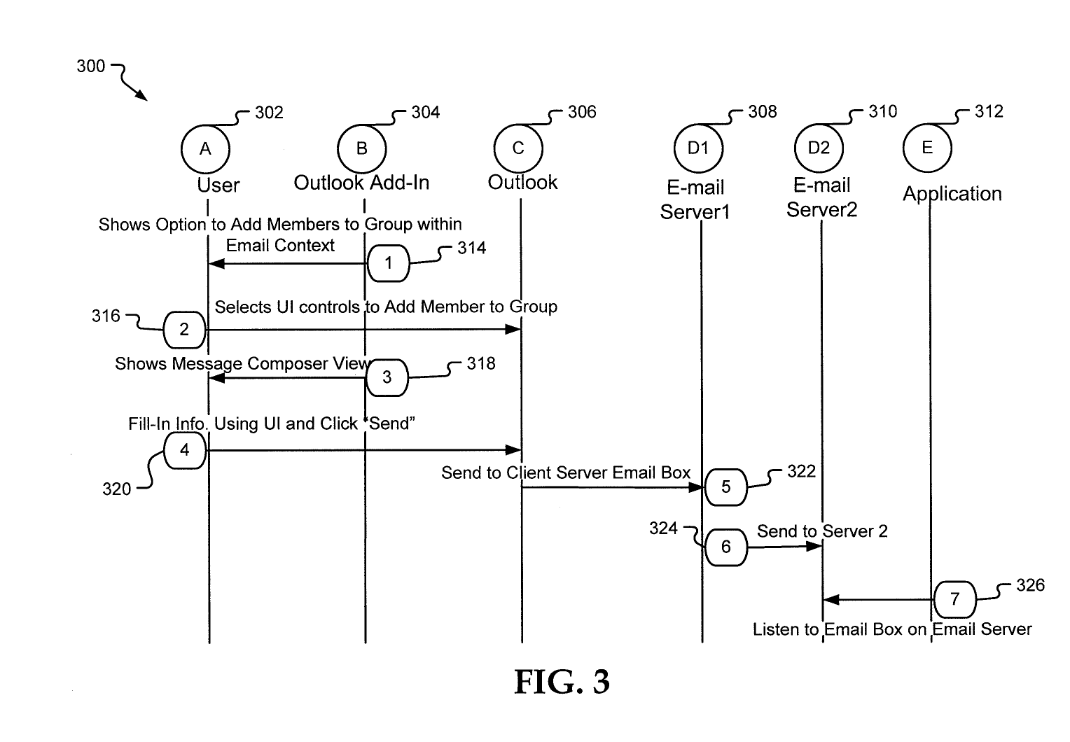

Process 200 is shown in flow chart 300 in FIG. 3 for initiating a request to a business process application 312 by a user 302 in accordance with an exemplary embodiment of the present invention. Process 200 begins with the email add-in 304 showing the email user 302 the option to add members to a group 314 within the email context (“step 1”) in accordance with an embodiment of the present invention. Such option may be shown to the user through icons, indicators, controls, text (such as “join group”), etc. Any number of displays and indicators may be used in accordance with embodiments of the present invention. As discussed, email add-in 304 allows the user 302 to enter his/her request for a business process application 312, and, in an embodiment, modifies the email client to provide UI controls to the user specific for the user's particular request, e.g., to join a group, change information, etc. Add-in 304 thus provides UI to initiate and compose the request, as well as to store the address to which the request is to be sent. In another embodiment, all such functions could be done natively in email client 306. However, where add-in 304 is used, add-in 304 provides UI functionality that may not be included in the email client application. Such increased, or different, functionality facilitates communications between the email user 302 and the business process application 312. In embodiments, the functionality provided by add-in 304 may allow the email client 306 to distinguish between a normal email message and a message request for action by a business process application. For example, add-in 304 adds the message composer view to the user interface screen, discussed further below in show message composer view operation 318, to enable the user to make the desired or required request to the business application. As noted, in another embodiment, email client add-in 304 is not a separate module but, instead, is integrated in the email client. In another embodiment, where an add-in is used, the system updates or increases the functionality of the non-functional, or legacy, version.

Upon reviewing the available options to make a request from within the context of the email client, the user 302 selects the appropriate UI control in the email client UI 306 for the desired request (“step 2”), such as to add a member to a group, in operation 316. Next, add-in 304 shows the message composer view of the desired request (“step 3”), such as to add a member to a group by way of example only, in show message operation 318. In another embodiment, the user indicates to the email client 306 UI that he/she desires to send a request and then is prompted to select which form he/she desires. The user may not know, or even care, to which application the form should be sent. Rather, the user might merely choose, by way of example only, the “vacation request form,” and the form or add-in or the email client would know where this form needs to be sent to be processed by the correct or appropriate application. In yet another embodiment, the user indicates to the email client 306 UI that he/she desires to send a request and then is prompted to select which application 312 he/she desires, upon which selection, the applicable form is displayed to the user for completion. The form that appears to the user is the UI representation of the mail message data. In accordance with embodiments of the present invention, numerous ways of initiating such a request and providing such form to the user can reasonably be understood by those of ordinary skill in the art. The user 302 is then able to provide the necessary information, and optionally, a business justification, using the email UI in fill-in operation 320 (“step 4”). Upon completion, the user 302 clicks “Send,” and the email client 306, in accordance with an embodiment of the invention, sends the form, or message request, to the email server 308 managing the mailbox of email client 306 in send operation 322 (“step 5”). In other embodiments, no add-in is used, and the message request is instead sent directly by the email client 306. Next, email server1 308 sends the request 324 to the email server2 310 managing the mailbox that is monitored by the business application (“step 6”). Finally, the business process application 312 monitors, or listens, to the email box managed by the email server2 310 in listen operation 326 to detect if any new messages have been received (“step 7”). Such monitoring occurs through the use of a mail agent (not shown) in accordance with embodiments of the present invention. The application can be configured to know at which mailbox to look. While FIG. 3 depicts operational characteristics of a method for modeling FIG. 2A's user's request to a business process as an email form, not all steps shown are necessarily required. Nor are all steps required in the order shown. Further, additional steps may be included in accordance with embodiments of the present invention.

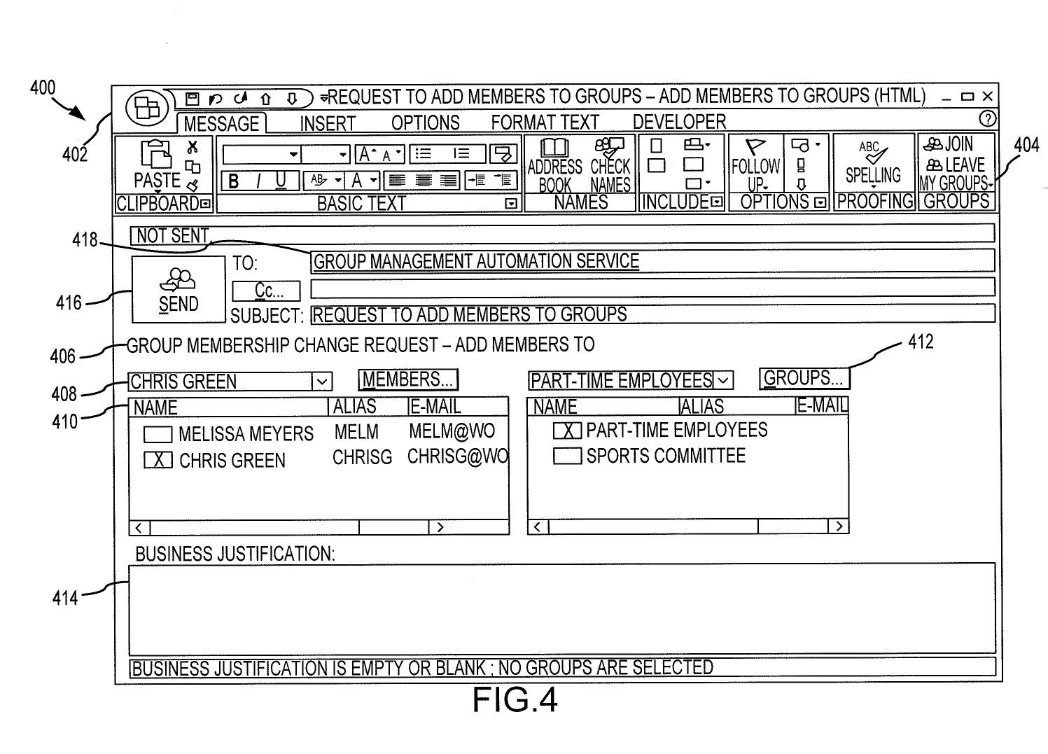

Turning now to FIG. 4, an exemplary screen shot 400 of the email UI for requesting action by a business process application using the form of an email is shown in accordance with an embodiment of the present invention. In an embodiment, the screen shot shows a request to add members to groups 402. While this specific action is depicted, any number of possible request types, e.g., reporting vacation or sick time, requesting a corporate cell phone, joining a distribution group, changing benefits, etc., may be reasonably conceived and understood by those of ordinary skill in the art. The controls or buttons for enabling such user requests are shown as icons and text in controls 404. For example, Groups controls 404 show “Join,” “Leave,” “My groups,” etc. Any number of possible controls may be considered in accordance with embodiments of the present invention. Clicking or otherwise selecting controls 404 for “join” groups causes the message composer view 402 to be displayed. With this view, the requested action, i.e., to add members to a group 406, is shown. Also shown are “Member . . . ” boxes 408 and “Group . . . ” boxes 412. The user is able to select members for adding to the group in box 410 and through the use of, for example, selection boxes next to each person's name. In the exemplary depiction of FIG. 4, the user has selected to add “Chris Green” to the group 412 of Part-Time Employees in accordance with an embodiment of the present invention. In other embodiments, a scroll-down menu of available members or groups or pop-up dialog boxes showing such may be displayed to the user upon the user's clicking of the controls, icons or buttons for “Members . . . ” or “groups . . . ,” respectively. In accordance with an embodiment of the present invention, upon selecting the desired group, the address of the necessary business process application for processing the request is automatically filled-out and displayed in the “To:” line 418 of the message by the email add-in based on an address configured with the add-in. In the exemplary embodiment shown, the email address in the “To:” line 418 is “Group Management Automation Service,” consistent with the example given of having a user initiate a request to add a member to a group. In such an embodiment, the display name is typically shown, as opposed to the entire email address, e.g., @entity.com. The email address listed in the “To:” line 418 is offered for example purposes only and is in no way intended to limit the scope of this invention. In such an embodiment, the address would not be user-editable. The mailbox for this email address is monitored by the business application. In other embodiments, the user may edit such address provided or may enter an address himself/herself, such as the address of the desired destination. In further embodiments, the user may also enter a business justification in text entry field 414 before sending the message request by clicking “Send” 416.

As discussed above in accordance with an embodiment of the present invention, upon clicking “Send” 416, the message request is transmitted to the user's Outbox, and, from there, the email client sends the request to the user's email server. If a separate server manages the business process application's mailbox, the user's email server then sends the request to the business application's email server, where the message is detected. The business application detects that a message is present by listening for, or monitoring, the appropriate mailbox on the application's server for new messages.

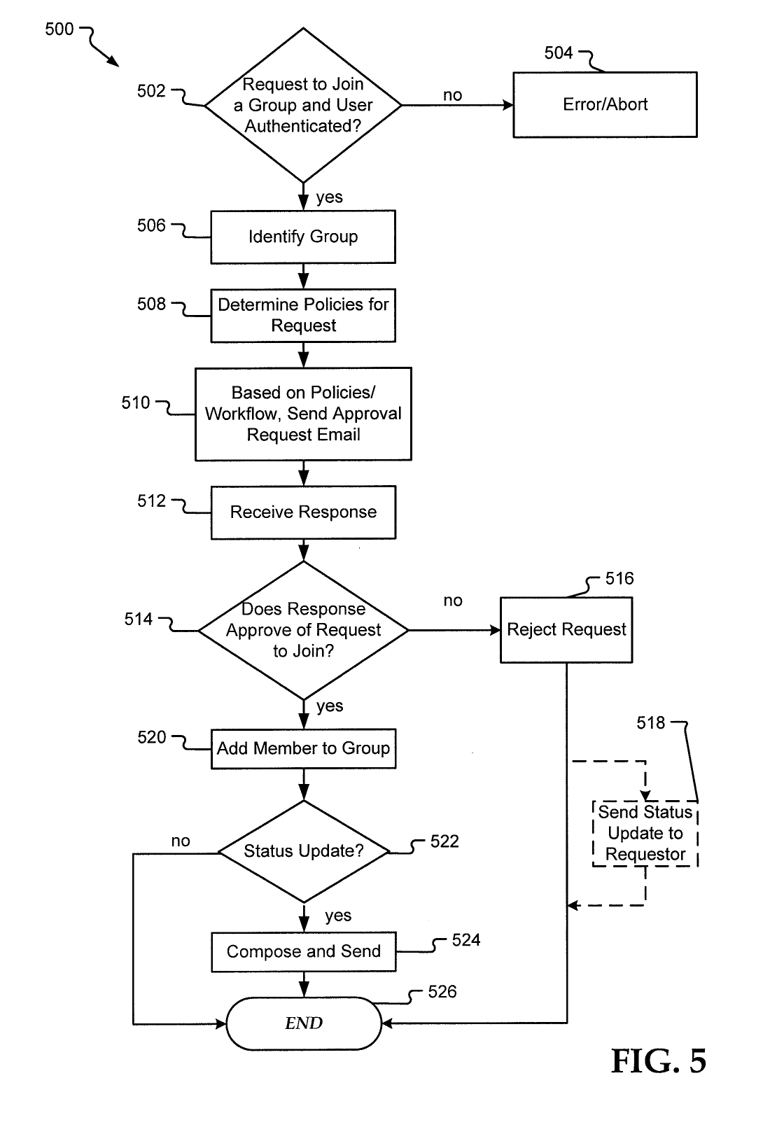

In accordance with an embodiment of the present invention, when the business application receives a new message, it reads the message and processes the request, as shown generally in process 500 shown in FIG. 5. Process 500 begins with query 502, in which the business application determines whether the request by the user is of a type that is capable of being processed by the business application and, in an embodiment, whether the user is authenticated to make the request. Authentication may be accomplished by simple token or certificate-based authentication by the system, for example. Any number of ways of identifying the user may be reasonably understood by those of ordinary skill in the art. Further, in another embodiment, it may be necessary to achieve authorization, e.g., approval from another entity, for processing the user's request. In embodiments, both authorization and authentication of the user are required. In other embodiments, only one is required. Further yet, neither authentication nor authorization is necessary in accordance with yet another embodiment of the present invention. In the exemplary embodiment of FIG. 5, the request type is a request to join a group. If such is not the nature of the request, process 500 branches NO to Error/Abort operation 504 because it would only be caused by an error in the system that a message request would arrive in the business application's mailbox that was not of a request type capable of being processed by the business application listening to that mailbox. If it is confirmed that the request is of the type capable of being processed by the application, e.g., a request to join a group, flow 500 branches YES to identify the group requested operation 506. Upon identifying the group requested, the business application then determines the policies and associated workflows that apply to the request 508. Such policies and workflows are determined 508 based on attributes of the request and policies that apply globally to the system; in other words, policies apply more broadly than to the specific group requested. While operation 506 involves identifying the group requested, this identification may occur before or after operation 508's determination of the policies applicable to the request. Such policies include, by way of example only, the person responsible for group membership, the number of members allowed in the group, the process for obtaining approval of an addition or removal of a member, etc. Further, policies may apply based on the user making the request, the users he/she wants to add/remove from a group, the state of the system, different time and calendar policies, among others. For example, a user may request to add other members to/from groups, not just to add or remove himself/herself, in accordance with an embodiment of the present invention. It is important to note that process 500 provides the general steps for detecting a new message request, receiving the new request, and processing it. In processing the request, numerous steps are involved, such as, by way of example only, authenticating the sender and authorizing the user's right to make the request. For example, based on the policies and workflow(s) associated with the group requested, an email requesting approval of the addition of a member to the group is sent to the designated person(s) or entity responsible for providing such approvals or rejections in send approval request email 510. In other embodiments, such approval occurs automatically. In accordance with embodiments of the present invention, numerous types of approval requests or other requests for responses may be used as reasonably understood by those of ordinary skill in the art. For example, such emails may be sent using the email UI of the email client and providing means for the user to respond to the approval request of the email. Such a process is explained in further detail in U.S. patent application Ser. No. ______, filed Jun. 29, 2007, and entitled, “Human Interaction with Application from Email Client,” which claims priority to U.S. Provisional Application Ser. No. 60/888,277, filed on Feb. 5, 2007, and entitled, “Human Interaction with Application from Email Client.” These applications are incorporated herein by reference and are commonly assigned to Microsoft Corporation of Redmond, Wash.

Upon receiving a response to the approval request in receive operation 512, the business application determines whether the response approves of the request to join the group in query operation 514. If the response denies such request, flow branches NO to reject user request operation 516, in which process 500 is then terminated at end operation 526. In rejecting the request, the business application may optionally send a status update, or notice, to the requester indicating that the request was rejected in optional send status update operation 518. The optional nature of this operation is shown by the dashed-lines format of this operation. On the other hand, if the response approves such request, flow branches YES to add member to group operation 520, in which the request action is taken. Process 500 then proceeds to query operation 522 where the business application determines whether a status update should be sent to the user notifying him/her that the requested action was approved and executed, e.g., that the specified member was added to the specified group. In an embodiment, the business application is pre-configured to specify whether a status update should be sent. In other embodiments, the user specifies in the request form whether a status update is desired, and the data structure accompanying the request is interpreted to notify the business application of such a request for a status update. If no status update is required, process 500 branches NO and terminates at end operation 526 in accordance with an embodiment of the present invention. If a status update is required, process 500 branches YES to compose and send status update operation 524, in which a status update is composed and sent. Upon sending the status update, process 500 terminates at end operation 526. In embodiments, the functionality provided by the email add-in and method allows the user to cancel a pending request to a business application that was previously sent via email. In further embodiments, a user may update a previously-made request by modifying or deleting information provided or requested. While process 500 has been provided for illustrating the steps in the exemplary method of submitting a request to join a group to a business application, these steps can occur in other sequences. For example, the business process application might send a status update immediately upon receiving the message, to let the user know the message was received or, alternatively, that it could not be processed due to some error. Further, steps shown in FIG. 5 could be combined and/or additional steps may be added without departing from the spirit and scope of the invention.

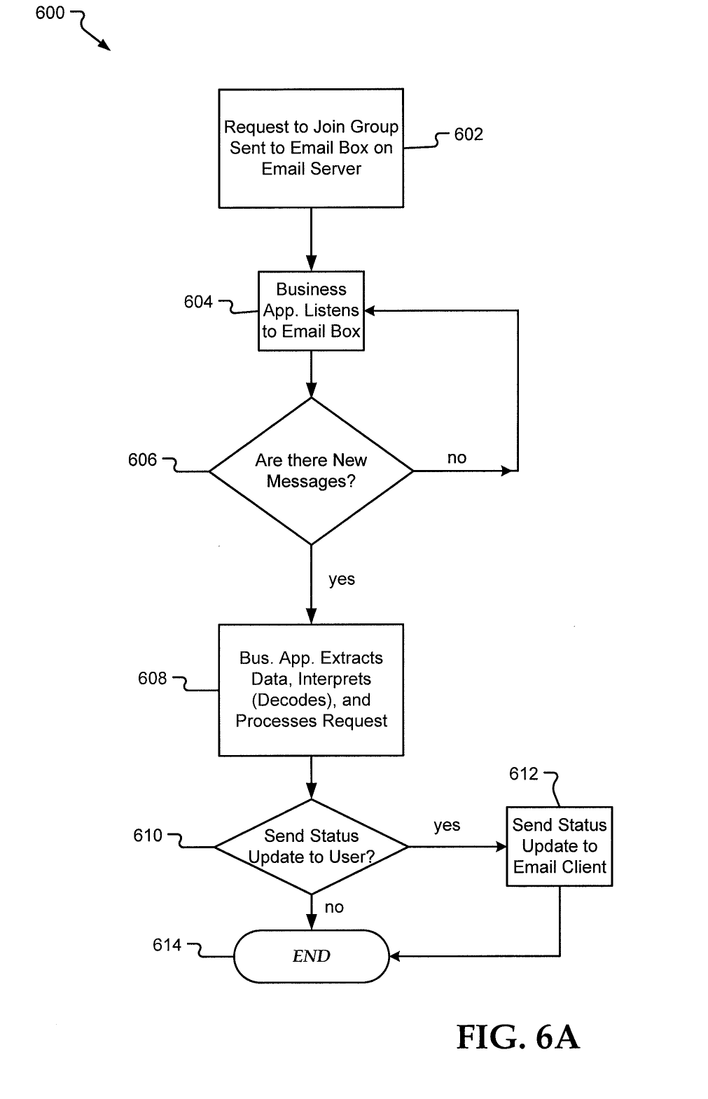

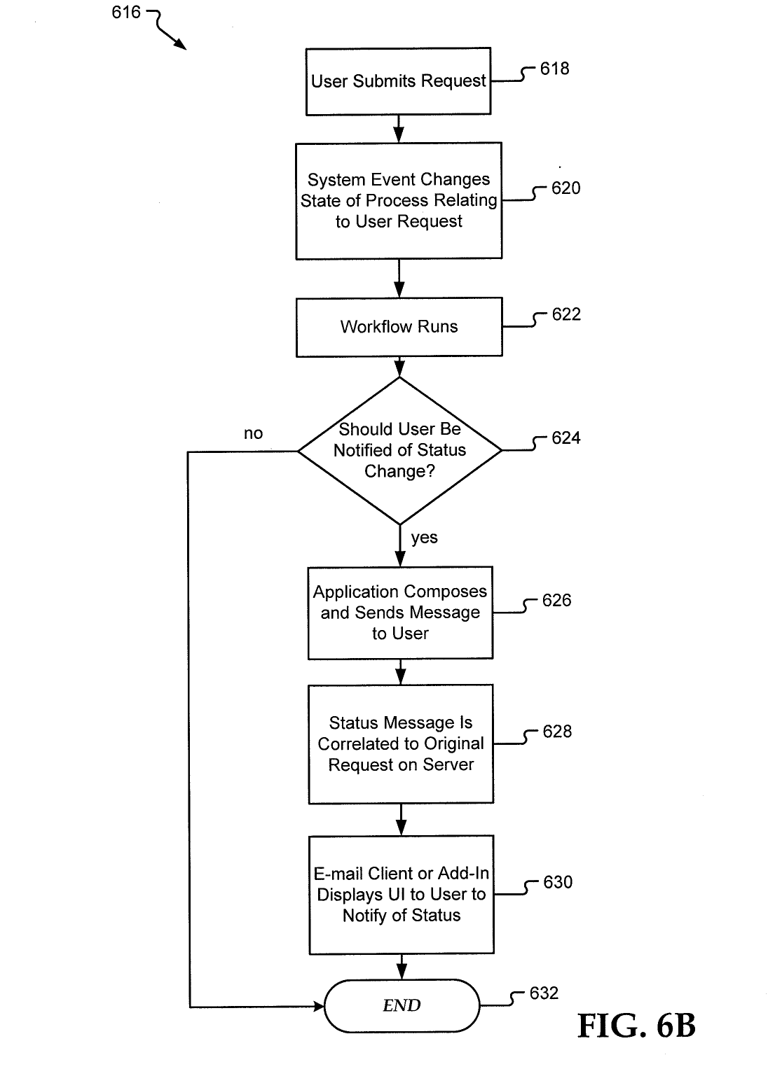

Next, turning to FIG. 6A, process 600 for the business application acting upon the message request and, in accordance with embodiments, sending a status update to the email client is illustrated. Process 600 begins with the sending of a request initiated by a user to join a group 602, for example, to the email box on the email server managing the user's mailbox. The business process application listens to the email box on the email server managing its mailbox in listen operation 604 to detect whether any new messages applicable to that particular business application have been received. In determining whether there are any new messages in query operation 606, process 600 branches NO to continue listening for messages 604 where none is detected. If a message is detected, flow branches YES to process operation 608, in which the business application processes the data structure accompanying the message request by extracting the data, interpreting, or decoding, the data, and processing the requested action. Upon processing the requested action, process 600 branches to query operation 610 to determine whether to send a status update to the user regarding the processing of the request. A status update may be required if an event in the system, for example, changes the state of the process that relates to the user request and the business application is configured to require a response to such a change by sending a status request, in accordance with an embodiment of the present invention. An event in the system that changes the state of the process could, by way of example only, be a date change reflecting a holiday or weekend date. In another embodiment, the event is initiated by another user(s) or entity. In yet another embodiment, the status update is sent based on the request of the user to send such an update or based on the policies of the system and/or request type. If no such status update is required, flow branches NO to end operation 614 which terminates process 600. If a status update is desired, flow branches YES to send status update operation 612, in which a status update is sent to the user utilizing the form and email client UI of the original message request sent to the business application. In an embodiment, the business application knows the address to which to send the status update based on the email address of the incoming request to the business application. In another embodiment, the business application looks up the primary email address of the user who sent the initial request and then uses that address for sending the status update. Such an embodiment is particularly useful where, for example, the request is made from a proxy email address, as opposed to the primary email address of the user. Numerous ways of determining the address for transmitting the status update to the user may be reasonably understood by those of ordinary skill in the art in accordance with embodiments of the present invention. Process 600 then terminates at end operation 614.

While FIG. 6A shows the general steps for receiving and processing a user-initiated request to a business process application, including the general steps for sending a status update, FIG. 6B illustrates the detailed process 616 for sending a status update relating to such request to the user. Process 616 is initiated when the user submits a request for a particular action in submit request operation 618. If the business process application to which such request is directed has a system event or process change relating to the user request 620, a workflow is triggered and run 622 for determining whether the user should be notified of the change in status query 624. If the user does not require a status update, process 616 branches NO to end operation 632 and process 616 terminates. On the other hand, if the user requires a status update, process 616 branches YES to compose and send message operation 626, in which the application composes and sends a message to the user who made the request, notifying the user of the applicable status update. In an embodiment, the user receives an email with the status update.

In another embodiment, the status update and the original request are correlated so that the current status of the request is displayed to the user if and when the user operates UI (other than the text of the status update message) to view that status. Examples of such UI operations include, for example: The user opens the original message request now located in the user's “Sent Items” box; or the user looks in UI provided by the email client that displays the status of multiple requests in one UI surface, message view, or preview pane. In an embodiment, correlation with message request 628 occurs on the email client. In other embodiments, correlation with the message request 628 occurs on the email server(s) managing the user's mailbox or on the email server managing the mailbox of the business application. In another embodiment, this correlation occurs on servers other than, or in addition to, the server managing the user's email client or the server managing the mailbox of the business application. This correlation occurs in the background and does not require user interaction. Further, such correlation is not evident to the user. In other words, the user is not necessarily aware of the concept of “correlation.” Instead, the user knows that when he/she operates UI that displays the status of a request, the last-known status of that request is provided. This last-known status is provided by correlating the messages that correspond to a specific request and displaying to the user the process state as reported in the last message. As discussed, in an embodiment, such correlation may be made by the use of a process ID shared by the original request and the business application message in accordance with an embodiment of the present invention. Numerous ways of correlating the request to the user and to the business application could reasonably be used by those of ordinary skill in the art in accordance with embodiments of the present invention.

Upon correlating the status update to the correct user, the email client or add-in displays UI 630 to the user to notify the user of the status of the request. As noted above, such display may be accomplished in a number of ways, such as by sending a new email to the user, updating the original request sent by the user now located in the user's “Sent Items” mailbox, etc. After notifying the user of the status update, process 600 then terminates at end operation 632. Again, steps may be combined, steps may be deleted, and/or steps may be added to process 600 without departing from the spirit and scope of the present invention. For example, a status update could be automatically sent following workflow run operation 622.

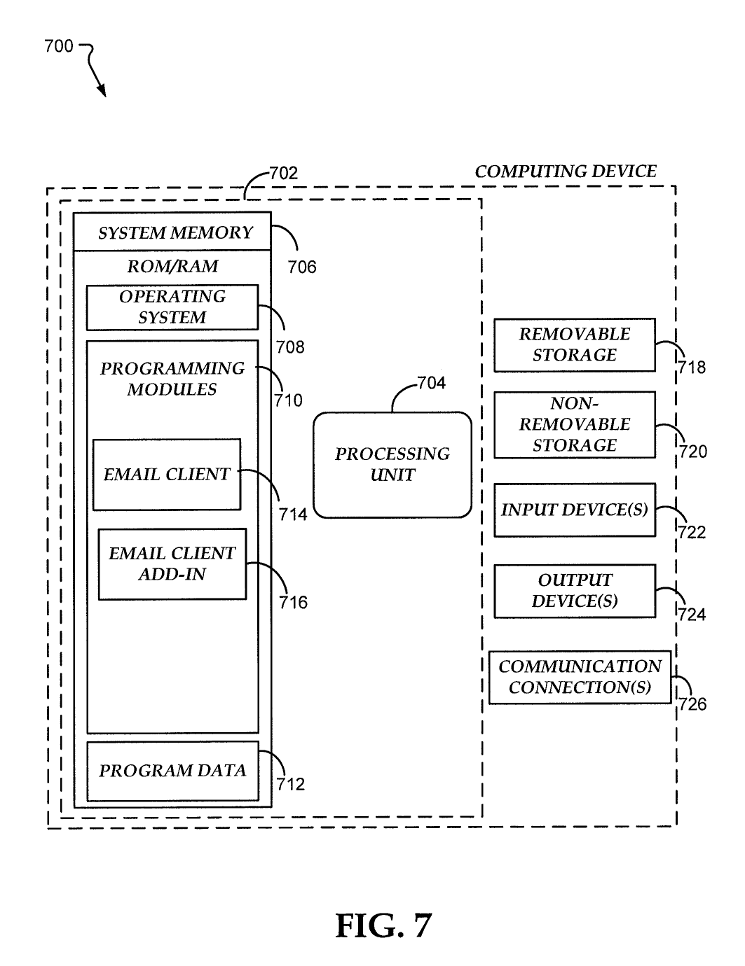

Turning now to FIG. 7, this figure is a block diagram of a system including a computing device 700, which may be used in conjunction with servers 102, 104, etc., and computer 112, for example. Consistent with an embodiment of the invention, any suitable combination of hardware, software, or firmware may be used to implement a memory storage and processing unit. For example, the memory storage and processing unit may be implemented with the computing device 700 or any other computing devices in combination with the computing device 700. The aforementioned system, device, and processors are examples and other systems, devices, and processors may comprise the aforementioned memory storage and processing unit, consistent with embodiments of the invention. Furthermore, the computing device 700 may comprise an operating environment for an associated system. The system may operate in other environments and is not limited to computing device 700.

With reference to FIG. 7, a system consistent with an embodiment of the invention may include a computing device, such as computing device 700. In a basic configuration, computing device 700 may include at least one processing unit 704 and a system memory 706. Depending on the configuration and type of computing device, system memory 706 may comprise, but is not limited to, volatile (e.g. random access memory (RAM)), non-volatile (e.g. read-only memory (ROM)), flash memory, or any combination. System memory 706 may include operating system 708, one or more programming modules 710, and may include program data 712. Operating system 708, for example, may be suitable for controlling computing device 700's operation. In one embodiment, programming modules 710 may include a document creation application for creating and editing a document. Programming modules 710 may include an email client 714 for sending and receiving email and an email client add-in 716 for, among other purposes, and in accordance with an embodiment of the present invention: (1) rendering UI controls and dialogs that are not part of the email client for purposes of enabling a user to send a request to a business application using an email form; and (2) managing the exchange of information, or communications, between a user of an email client and a business process application. In other embodiments where FIG. 7 describes a server, programming module 710 may be a business processing application or a database management system. As discussed above, the business processing application and/or database management system are located on different computers than the email client in accordance with an embodiment of the invention. Furthermore, embodiments of the invention may be practiced in conjunction with a graphics library, other operating systems, or any other application program and are not limited to any particular application or system. This basic configuration is illustrated in FIG. 7 by those components within dashed line 702.

Computing device 700 may have additional features or functionality. For example, computing device 700 may also include additional data storage devices (removable and/or non-removable) such as, for example, magnetic disks, optical disks, or tape. Such additional storage is illustrated in FIG. 7 by a removable storage 718 and a non-removable storage 720. Computer storage media may include volatile and nonvolatile, removable and non-removable media implemented in any method or technology for storage of information, such as computer readable instructions, data structures, program modules, or other data. System memory 706, removable storage 718, and non-removable storage 720 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 700. Any such computer storage media may be part of device 700. Computing device 700 may also employ input device(s) 722 such as a keyboard, a mouse, a pen, a sound input device, a touch input device, etc. Output device(s) 724 such as a display, speakers, a printer, etc. may also be included. The aforementioned devices are examples and others may be used.

Computing device 700 may also contain a communication connection(s) 726 that may allow computing device 700 to communicate with other computing devices, such as over network 110 in FIG. 1 in a distributed computing environment, for example, an intranet or the Internet. Communication connection(s) 726 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 706, including operating system 708. While executing on processing unit 704, programming modules 710 may perform processes including, for example, one or more method stages as described above. The aforementioned process is an example, and processing unit 704 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or implement particular abstract data types. Moreover, embodiments of the invention may be practiced with other computer system configurations, including hand-held devices, e.g., phones, cell phones or other similar mobile devices, personal digital assistants, smartphones, multiprocessor systems, microprocessor-based or programmable consumer electronics, minicomputers, mainframe computers, and the like, in which the forms, or message requests, of the present invention are submitted via such devices. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general-purpose computer or in any other circuits or systems.

Embodiments of the invention, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list) may include the following: an electrical connection having one or more wires, a portable computer diskette, a random access memory (RAM), a read-only memory (ROM), an erasable programmable read-only memory (EEPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, certain blocks may not be executed at all.

Although certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, as noted, the disclosed methods' stages may be modified in any manner, including by reordering stages and/or inserting or deleting stages, without departing from the spirit or scope of the invention.

While the specification includes examples, the invention's scope is indicated by the following claims. Furthermore, while the specification has been described in language specific to structural features, methodological acts, and/or computer-readable media containing such acts, the claims are not limited to the features or acts described above. One skilled in the art will recognize other embodiments or improvements that are within the scope and spirit of the present invention. Therefore, the specific structures, features, acts, or media are disclosed only as illustrative embodiments. The invention is defined by the appended claims.

What is claimed is:

1. A method for enabling a user to initiate a request for action to a business process application from a general-purpose email client, the method comprising:
displaying a control in the electronic mail (email) user interface to formulate a request for an action by the business process application;
displaying in electronic form the message composer view associated with the request;
providing for the input of information in the message request; and
providing for the transmittal of the message request from the user to the business process application.

2. The method of claim 1, wherein the email message containing the request is first transmitted to the email client's mailbox.

3. The method of claim 1, the method further comprising:
monitoring the business application's email box to determine if a new message is present; and
if a new message is present, processing the request.

4. The method of claim 3, wherein a data structure for communicating with the desired business process application accompanies the request.

5. The method of claim 4, wherein processing the request involves extracting and interpreting the data from the data structure accompanying the request.

6. The method of claim 4, the method further comprising:
including encrypted data in the data structure.

7. The method of claim 4, the method further comprising:
using rights management technology to preserve the confidentiality of the request.

8. The method of claim 1, the method further comprising sending a status update relating to the request as an email from the business application to the user.

9. The method of claim 1, the method further comprising providing a status update regarding the processing of a request in the UI of the original request item viewed by the user in the email client.

10. The method of claim 1, the method further comprising:
receiving by the business process application a user's request to take an action;
authenticating the user; and
if the user is authenticated, processing the request.

11. The method of claim 10, the method further comprising:
requesting the necessary authorization related to the request;
receiving authorization for the user to take the requested action; and
executing the requested action.

12. The method of claim 11, the method further comprising:
if no authorization is received, sending a notice of rejection to the user in the UI of the email form of the request.

13. The method of claim 11, the method comprising:
upon processing the request, sending an update to the user by electronic mail (email) to indicate a change in the status of the request, including one or more of the following: approved, rejected, canceled, and pending; and
displaying the change in the status of the request to the user through one or more of the following: the email client and the email client add-in.

14. A system for enabling a user to initiate a request for action to a business process application from a general-purpose email client, comprising:
a display module for displaying a control in the electronic mail (email) user interface to formulate a request for an action by the business process application;
an input module and display module for allowing a user to complete the necessary information in the message request; and
an executing module for sending the message request from the user to the business process application.

15. A system as defined in claim 14, further comprising:
a detection module for monitoring the business application's email box to determine if a new message is present; and
if a new message is present, processing the request.

16. A system as defined in claim 14, further comprising:
an email client or email client add-in for displaying user interface controls to the user based on the email message request type initiated by the user.

17. A system as defined in claim 14, further comprising:
an email client or email client add-in for performing one or more of the following: recording the user's request, determining the address of the necessary business process application to which to send the user's request, sending the user's request to the business application, and sending a status update from the business process application to the user using the UI of the email client of the request.

18. A computer storage medium containing executable instructions which when executed by a computer perform a method of enabling a user to initiate a request for action to a business process application from a general-purpose email client, comprising:
displaying a control in the electronic mail (email) user interface to formulate a request for an action by the business process application;
receiving in electronic form the message composer view associated with the request;
displaying information for allowing a user to complete the necessary information in the message request; and
sending the message request from the user to the business process application.

19. The computer storage medium as defined in claim 18, wherein an email client add-in is integrated into the email client for performing one or more of the following: displaying user interface controls and recording the user's request to the business process application.

20. The computer storage medium as defined in claim 18, wherein a status update is provided to the user using the UI of the email client used to formulate the request.
